(19) United States
(12) Patent Application Publication
(10) Pub. No.: US 2012/0200928 A1
(43) Pub. Date: Aug. 9, 2012

(54) Plate Member For Touch Panel and Method of Manufacturing the Same

(75) Inventors: Byung Soo Kim, Seoul (KR); Keun Sik Lee, Seoul (KR); Chung Won Seo, Seoul (KR); Ji Won Jo, Seoul (KR); Hyuk Jin Hong, Seoul (KR)

(73) Assignee: LG INNOTEK CO., LTD., Seoul (KR)

(21) Appl. No.: 13/501,026

(22) PCT Filed: Oct. 7, 2010
(86) PCT No.: PCT/KR2010/006871

§ 371 Date: Apr. 9, 2012

(30) Foreign Application Priority Data
Oct. 8, 2009 (KR) 10-2009-0095836

(51) Int. Cl. G02B 1/11

(52) U.S. Cl. 359/585

(57) ABSTRACT

A plate member for touch panel and a method of manufacturing the same are provided. The plate member for touch panel includes: a base substrate; a first intermediate layer disposed on a first side of the base substrate and having a first refractive index; a second intermediate layer disposed on the first intermediate layer and having a second refractive index lower than the first refractive index; and a transparent conductive layer disposed on the second intermediate layer.

### TECHNICAL FIELD

The present disclosure relates to a plate member for touch panel and a method of manufacturing the same.

### BACKGROUND ART

In the latest diverse electronic products, a touch panel with an inputting method through which a finger or an input device such as a stylus is used to contact an image displayed on a display device is applied.

The touch panel may be divided into a touch panel of a resistive layer type and a touch panel of an electrostatic capacity type. In the touch panel of a resistive layer type, a position is detected when an electrode becomes a short circuit by pressure of an input device. In the touch panel of an electrostatic capacity type, a position is detected when an electrostatic capacity between electrodes is changed by finger contact.

A plate member used for those touch panels may include a base substrate and a transparent conductive layer thereon. At this point, if the transparent conductive layer is directly disposed on the base substrate, a crack may occur in the transparent conductive layer, so that an additional intermediate layer may be disposed between the base substrate and the transparent conductive layer.

In the plate member, it is an important task that besides transmittance improvement, when the transparent conductive layer is patterned for a pattern, the pattern needs to be invisible from the external.

### DISCLOSURE OF INVENTION

### Technical Problem

Embodiments provide a plate member for touch panel for improving transmittance and preventing a pattern of a transparent conductive layer from being visible from the external and a method of manufacturing the same.

### Solution to Problem

In one embodiment, a plate member for touch panel includes: a base substrate; a first intermediate layer disposed on a first side of the base substrate and having a first refractive index; a second intermediate layer disposed on the first intermediate layer and having a second refractive index lower than the first refractive index; and a transparent conductive layer disposed on the second intermediate layer.

The transparent conductive layer may have a third refractive index lower than the second refractive index.

The plate member may further include at least one outer layer on a second side of the base substrate.

The outer layer may include: a first outer layer disposed on the second side of the base substrate; and a second outer layer disposed on the first outer layer and having a refractive index lower than the first outer layer.

Each of the first and second outer layers may include at least one of Mg, F, Si, Al, Ce, In, Hf, Zr, Pb, Ti, Ta, Nb and O.

The first outer layer may include at least one of ZrO₂, Pb₅O₁₁, TiO₂, Ta₂O₅, and Nb₂O, and the second outer layer may include at least one of Al₂O₃, CeF₃, SiO, In₂O₃, HfO₂, MgF₂, and SiO₂.

The first outer layer may include at least one of Al₂O₃, CeF₃, SiO, In₂O₃, and HfO₂ and the second outer layer may include at least one of MgF₂ and SiO₂.

A thickness of each of the first intermediate layer, the second intermediate layer, and the transparent conductive layer may range from 1 nm to 100 nm.

A thickness of the outer layer may range from 1 nm to 100 nm.

Each of the first and second intermediate layers may include at least one of Mg, F, Si, Al, Ce, In, Hf, Zr, Pb, Ti, Ta, Nb and O.

The first intermediate layer may include at least one of ZrO₂, Pb₅O₁₁, TiO₂, Ta₂O₅, and Nb₂O₅ and the second intermediate layer may include at least one of Al₂O₃, CeF₃, SiO, In₂O₃, HfO₂, MgF₂, and SO₂.

The first intermediate layer may include at least one of Al₂O₃, CeF₃, SiO, In₂O₃, and HfO₂ and the second intermediate layer may include at least one of MgF₂ and SiO₂.

The transparent conductive layer may include respectively spaced patterns; and when a reflectance of light reflected by a portion with the pattern is R0 and a reflectance of light reflected by a portion with no pattern is R1, the R0 and R1 may satisfy the following condition. Ro−R1<0.7%.

In another embodiment, a method of manufacturing a plate member for touch panel includes: forming a first intermediate layer having a first refractive index on a first side of a base substrate; forming a second intermediate layer having a second refractive index lower than the first refractive index on the first intermediate layer; and forming a transparent conductive layer on the second intermediate layer.

The transparent conductive layer may have a third refractive index lower than the second refractive index.

The method may further include forming at least one outer layer on a second side of the base substrate.

The outer layer may include: a first outer layer disposed on the second side of the base substrate; and a second outer layer disposed on the first outer layer and having a refractive index lower than the first outer layer.

Each of the first and second intermediate layers may include at least one of Mg, F, Si, Al, Ce, In, Hf, Zr, Pb, Ti, Ta, Nb and O.

The first intermediate layer may include at least one of ZrO₂, Pb₅O₁₁, TiO₂, Ta₂O₅, and Nb₂O₅ and the second intermediate layer may include at least one of Al₂O₃, CeF₃, SiO, In₂O₃, HfO₂, MgF₂, and SiO₂.

The first intermediate layer may include at least one of Al₂O₃, CeF₃, SiO, In₂O₃, and HfO₂ and the second intermediate layer may include at least one of MgF₂ and SiO₂.

The details of one or more embodiments are set forth in the accompanying drawings and the description below. Other features will be apparent from the description and drawings, and from the claims.

### Advantageous Effects of Invention

According to the embodiment, the transmittance of the plate member of the touch panel can be improved and a pattern of the transparent conductive layer can be prevented from being visible from the external.

### BRIEF DESCRIPTION OF DRAWINGS

FIG. 1 is a sectional view of a plate member for touch panel according to a first embodiment.

FIG. 2 is a sectional view of a plate member for touch panel according to a modification.

FIG. 3 is a sectional view illustrating a plate member for touch panel according to a second embodiment.

FIG. 4 is a flowchart illustrating a method of manufacturing a plate member according to an embodiment.

### BEST MODE FOR CARRYING OUT THE INVENTION

In the descriptions of embodiments, it will be understood that when a layer (or film), a region, a pattern, or a structure is referred to as being ‘on/above’ or ‘below/under’ a substrate, a layer, (or film), a region, or a pattern, it can be directly ‘on/above’ or ‘below/under’ the substrate, the layer (or film), the region, or the pattern, intervening layers may also be present. Reference about ‘on/above’ or ‘below/under’ of each layer will be described based on the accompanying drawings.

In the accompanying drawings; the thickness or size of each layer (or film), region, pattern or structure may be modified for clarity and convenience and thus does not entirely reflect an actual size thereof.

Hereinafter, embodiments will be described in detail with reference to the accompanying drawings.

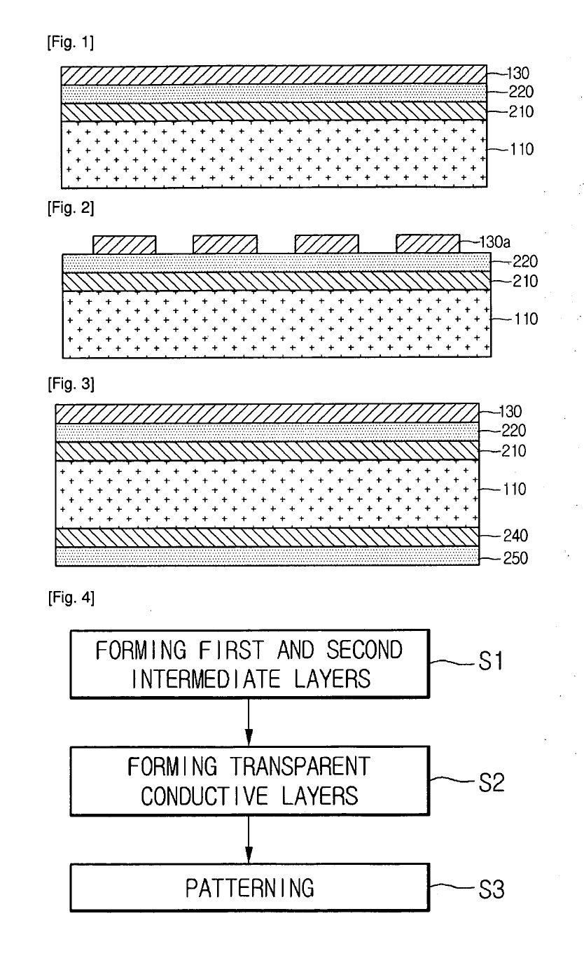

FIG. 1 is a sectional view of a plate member for touch panel according to a first embodiment.

Referring to FIG. 1, the plate member for touch panel (hereinafter, referred to as a plate member) includes a base substrate 110, and a first intermediate layer 210, a second intermediate layer 220, and a transparent conductive layer 130, which are disposed sequentially on the first side (hereinafter, referred to as the top surface) of the base substrate 110.

Here, the base substrate 110 is a plastic sheet or a plastic film and its material has a high transmittance of a visible ray (between 400 nm and 700 nm).

For example, the material may use Acrylic resin, Polycarbonate resin, Polyethylene napthalate resin, Polyethylene terephthalate (PET) resin, Poly Propylene resin, Poly aryl resin, Polyether sulfone (PES) resin, PolyMethly Pentene resin, Poly Ether Ether. Ketone resin, Polysulfone (PSF) resin, Acetic cellulose resin, Amorphous polyolefin resin, Polyethylene resin, Polyester resin, Epoxy resin, Polyamide resin, PAI resin, PPS resin, PEI resin, Olefin resin, Vinyl resin, and Fluorine resin.

For example, more than two types of those resins are processed using pneumatic press to form a plastic sheet or a plastic film. Additionally, at least two plastic sheets or plastic films formed of the above resin may be stacked or pressed. Additionally, a protective layer (not shown) of 5 to 100 formed of another resin may be disposed on the surface of a plastic sheet or a plastic film.

The first intermediate layer 210, the second intermediate layer 220, and the transparent conductive layer 130, which are disposed sequentially on the first side (hereinafter, referred to as the top surface) of the base substrate 110, will be described as follows.

At this point, the first intermediate layer 210 may have a first refractive index and the second intermediate layer 220 may have a second refractive index. That is, a refractive index becomes smaller as being far from the base substrate 110. Accordingly, this embodiment may improve transmittance of a plate member. At this point, the transparent conductive layer 230 may have a third refractive index lower than the second refractive index, thereby improving transmittance further. However, the present invention is not limited thereto, and a refractive index of the transparent conductive layer 230 may be higher than that of the second refractive index.

This will be described as follows.

In general, when a number of material layers having different refractive indices are stacked, reflection and refraction of light occur at interfaces therebetween. At this point, light transmittance may be reduced by reflection loss. Accordingly, the embodiment reduces reflectance through optical interference phenomenon by stacking the first intermediate layer 210 of a relatively high refractive index and the second intermediate layer 220 of a relatively low refractive index. Additionally, transmittance may be improved by coating the base substrate 110 with a material having a refractive index lower than the base substrate 100.

The transparent conductive layer 130 may include conductive materials of various transmittances, and may include indium tin oxide (ITO). The first and second intermediate layers 210 and 220 may include at least one of Mg, F, Si, Al, Ce, In, Hf, Zr, Pb, Ti, Ta, Nb and O.

As one example, the first and second intermediate layers 210 and 220 may formed of ZrO₂, Pb₅O₁₁, TiO₂, Ta₂O₅, Nb₂O₅, Al₂O₃, CeF₃, SiO, In₂O₃, HfO₂, MgF₂, and SiO₂ and may appropriately select their refractive indices. At this point, they are classified in Table 1 below based on a low refractive index material, an intermediate refractive index material, and a high refractive index material.

TABLE 1

| Classification | Material | Refractive index |
|---|---|---|
| Low refractive index | MgF₂ | 1.38 |
| material | SiO₂ | 1.46 |
| Intermediate refractive | Al₂O₃ | 1.62 |
| index material | CeF₃ | 1.63 |
| | SiO | 2.00 |
| | In₂O₃ | 2.00 |
| | HfO₂ | 2.00 |
| High refractive index | ZrO₂ | 2.10 |
| material | Pb₅O₁₁ + TiO₂ | 2.10 |
| | Ta₂O₅ | 2.15 |
| | Nb₂O₅ | 2.2-2.4 |
| | TiO₂ | 2.2-2.7 |

In order for the first intermediate layer 210 to have a first refractive index and the second intermediate layer 220 to have a second refractive index lower than the first refractive index, the first intermediate layer 210 may be formed of a high refractive index material and the second intermediate layer 220 may be formed of an intermediate refractive index material or a low refractive index material. That is, the first intermediate layer 210 may include ZrO₂, Pb₅O₁₁, TiO₂, Ta₂O₅, and Nb₂O₅ and the second intermediate layer 220 may include Al₂O₃, CeF₃, SiO, In₂O₃, HfO₂, MgF₂, and SiO₂.

Or, the first intermediate layer 210 may be formed of an intermediate refractive index material and the second intermediate layer 220 may be formed of a low refractive index material. That is, the first intermediate layer 220 may include Al₂O₃, CeF₃, SiO, In₂O₃, and HfO₂, and the second intermediate layer 220 may include MgF₂ and SiO₂.

However, the present invention is not limited thereto, and although the same high refractive index material (or intermediate refractive index material or low refractive index material) is used, if a refractive index of the first intermediate layer 210 is relatively higher than that of the second intermediate layer 220, this is understood as being in the scope of the present invention.

Accordingly, this embodiment may improve transmittance of a plate member. As one example, if the first intermediate layer 210 of Nb₂O₅, the second intermediate layer 220 of SiO₂, and the transparent conducive layer 130 of ITO are sequentially disposed on the base substrate 110, its transmittance is 95%.

That is, compared to a related art plate member having light transmittance of 91%, where a SiO₂ layer and ITO are sequentially disposed on the base substrate, it is apparent the plate member according to an embodiment has significantly improved light transmittance.

Here, a thickness of each of the first intermediate layer 210, the second intermediate layer 220, and the transparent conductive layer 130 may range from 1 nm to 100 nm in consideration of optical characteristics and/or electrical characteristics.

Moreover, as shown in FIG. 2, if a transparent conductive layer 130a is patterned, this may not be visible from the external. In this case, this embodiment may prevent the pattern of the transparent conductive layer 130a from being recognized from the external by adjusting the refractive indices of the second intermediate layer 220 and the transparent conductive layer 130a.

In more detail, if a reflectance of a portion where a pattern of the transparent conducive layer 130a is R0 and a reflectance of a portion with no pattern is R1, when it satisfies the following Equation, the pattern of the transparent conductive layer 130a may not be recognized from the external.

Ro−R1<0.7% [Equation]

At this point, a refractive index is a value after transmittance is subtracted from 1, and thus a pattern of the transparent conductive layer 130a is not recognized by adjusting a refractive index.

Hereinafter, with reference to FIG. 3, a plate member according to another embodiment will be described in detail. Detailed description about the same or similar configuration of the first embodiment will be omitted, and only different parts will be described in more detail.

FIG. 3 is a sectional view illustrating a plate member for touch panel according to a second embodiment.

Referring to FIG. 3, compared to the first embodiment, the plate member further includes outer layers 240 and 250 on the second side (hereinafter, referred to as the bottom surface) of the base substrate 110. These outer layers 240 and 250 include a first outer layer 240 on the bottom surface of the base substrate 110 and a second outer layer 250 on the first outer layer 240.

At this point, a refractive index of the second outer layer 250 may be less than that of the first outer layer 240. Like this, reflectance may be reduced using optical interference phenomenon after the first outer layer 250 of a relatively high refractive index and the second outer layer 240 of a relatively low refractive index are stacked.

In the above descriptions and drawings, although the outer layers 240 and 250 are formed of two layers, the present invention is not limited thereto. Accordingly, when a plurality of outer layers 240 and 250 become far from the base substrate 110 and their refractive indices become smaller, this is also regarded as being in the scope of the present invention.

Each of the first and second outer layers 240 and 250 may include at least one of Mg, F, Si, Al, Ce, In, Hf, Zr, Pb, Ti, Ta, Nb and O. As one example, the outer layers 240 and 250 may be formed of ZrO₂, Pb₅O₁₁, TiO₂, Ta₂O₅, Nb₂O₅, Al₂O₃, CeF₃, SiO, In₂O₃, HfO₂, MgF₂, and SiO₂ and may appropriately select them in consideration of a refractive index.

In order for the first outer layer 240 to have a higher refractive index than the second outer layer 250, the first outer layer 240 may be formed of a high refractive index material and the second outer layer 250 may be formed of an intermediate or low refractive index material. That is, the first outer layer 240 may include ZrO₂, Pb₅O₁₁, TiO₂, Ta₂O₅, and Nb₂O₅ and the second outer layer 250 may include Al₂O₃, CeF₃, SiO, In₂O₃, HfO₂, MgF₂, and SiO₂.

Or, the first outer layer 240 may be formed of an intermediate refractive index material and the second outer layer 250 may be formed of a low refractive index material. That is, the first outer layer 240 may include Al₂O₃, CeF₃, SiO, In₂O₃, and HfO₂ and the second outer layer 250 may include MgF₂, and SiO₂.

However, the present invention is not limited thereto, and although the same high refractive index material (or intermediate refractive index material or low refractive index material) is used, if a refractive index of the first outer layer 240 is relatively higher than that of the second outer layer 250, this is understood as being in the scope of the present invention.

Here, a thickness of each of the first outer layer 240 and the second outer layer 250 may be 1 nm to 100 nm in consideration of optical characteristics and/or electrical characteristics.

This embodiment may further improve transmittance of a plate member by using the first and second outer layers 240 and 250.

As one example, if the first intermediate layer 210 of Nb₂O₅, the second intermediate layer 220 of SiO₂, and the transparent conducive layer 130 of ITO are sequentially disposed on the top surface of the base substrate 110 and the first outer layer 240 of Nb₂O₅ and the second outer layer 250 of SiO₂ are sequentially disposed on the bottom surface of the base substrate 110, its transmittance is 98%.

That is, compared to a related art plate member having light transmittance of 91%, where a SiO₂ layer and ITO are sequentially formed on the base substrate, it is apparent the plate member according to an embodiment has significantly improved light transmittance. Moreover, the plate member of this embodiment has more excellent transmittance than that of the first embodiment.

Furthermore, the plate member of the embodiment may be applied to a touch panel of a resistive layer type and a touch panel of an electrostatic capacity type. Accordingly, an optical character of the touch panel may be improved.

A method of manufacturing the plate member according to the embodiment will be described with reference to FIG. 4. Overlapping description will be omitted. FIG. 4 is a flowchart illustrating a method of manufacturing a plate member according to an embodiment.

First, a first intermediate layer and a second intermediate layer are formed on a base substrate in operation S1. Here, the base substrate may be the above mentioned plastic sheet or plastic film.

Next, a transparent conductive layer having smaller refractive index than the second intermediate layer is stacked on the second intermediate layer in operation S2.

Next, the transparent conductive layer is exposed and developed for patterning in operation S3. Here, the patterning may be used in a multi resistive layer type or an electrostatic capacity type.

Then, at least one outer layer may be further formed on the second side of the base substrate.

Any reference in this specification to one embodiment, an embodiment, example embodiment, etc., means that a, particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A plate member for touch panel comprising:
a base substrate;
a first intermediate layer disposed on a first side of the base substrate and having a first refractive index;
a second intermediate layer disposed on the first intermediate layer and having a second refractive index lower than the first refractive index; and
a transparent conductive layer disposed on the second intermediate layer.

2. The plate member according to claim 1, wherein the transparent conductive layer has a third refractive index lower than the second refractive index.

3. The plate member according to claim 1, further comprising at least one outer layer on a second side of the base substrate.

4. The plate member according to claim 3, wherein the outer layer comprises:
a first outer layer disposed on the second side of the base substrate; and
a second outer layer disposed on the first outer layer and having a refractive index lower than the first outer layer.

5. The plate member according to claim 4, wherein each of the first and second outer layers comprises at least one of Mg, F, Si, Al, Ce, In, Hf, Zr, Pb, Ti, Ta, Nb and O.

6. The plate member according to claim 5, wherein the first outer layer comprises at least one of ZrO₂, Pb₅O₁₁, TiO₂, Ta₂O₅, and Nb₂O₅ and the second outer layer comprises at least one of Al₂O₃, CeF₃, SiO, In₂O₃, HfO₂, MgF₂, and SiO₂.

7. The plate member according to claim 5, wherein the first outer layer comprises at least one of Al₂O₃, CeF₃, SiO, In₂O₃, and HfO₂ and the second outer layer comprises at least one of MgF₂ and SiO₂.

8. The plate member according to claim 1, wherein a thickness of each of the first intermediate layer, the second intermediate layer, and the transparent conductive layer ranges from 1 nm to 100 nm.

9. The plate member according to claim 3, wherein a thickness of the outer layer ranges from 1 nm to 100 nm.

10. The plate member according to claim 1, wherein each of the first and second intermediate layers comprises at least one of Mg, F, Si, Al, Ce, In, Hf, Zr, Pb, Ti, Ta, Nb and O.

11. The plate member according to claim 10, wherein the first intermediate layer comprises at least one of ZrO₂, Pb₅O₁₁, TiO₂, Ta₂O₅, and Nb₂O₅ and the second intermediate layer comprises at least one of Al₂O₃, CeF₃, SiO, In₂O₃, HfO₂, MgF₂, and SiO₂.

12. The plate member according to claim 10, wherein the first intermediate layer comprises at least one of Al₂O₃, CeF₃, SiO, In₂O₃, and HfO₂ and the second intermediate layer comprises at least one of MgF₂ and SiO₂.

13. The plate member according to claim 1, wherein the transparent conductive layer comprises respectively spaced patterns; and
when a reflectance of light reflected by a portion with the pattern is R0 and a reflectance of light reflected by a portion with no pattern is R1, the R0 and R1 satisfy the following condition.
Ro−R1<0.7%

14. A method of manufacturing a plate member for touch panel, the method comprising:
forming a first intermediate layer having a first refractive index on a first side of a base substrate;
forming a second intermediate layer having a second refractive index lower than the first refractive index on the first intermediate layer; and
forming a transparent conductive layer on the second intermediate layer.

15. The method according to claim 14, wherein the transparent conductive layer has a third refractive index lower than the second refractive index.

16. The method according to claim 14, further comprising forming at least one outer layer on a second side of the base substrate.

17. The method according to claim 16, wherein the outer layer comprises:
a first outer layer disposed on the second side of the base substrate; and
a second outer layer disposed on the first outer layer and having a refractive index lower than the first outer layer.

18. The method according to claim 14, wherein each of the first and second intermediate layers comprises at least one of Mg, F, Si, Al, Ce, In, Hf, Zr, Pb, Ti, Ta, Nb and O.

19. The method according to claim 18, wherein the first intermediate layer comprises at least one of ZrO₂, Pb₅O₁₁, TiO₂, Ta₂O₅, and Nb₂O₅ and the second intermediate layer comprises at least one of Al₂O₃, CeF₃, SiO, In₂O₃, HfO₂, MgF₂, and SiO₂.

20. The method according to claim 18, wherein the first intermediate layer comprises at least one of Al₂O₃, CeF₃, SiO, In₂O₃, and HfO₂ and the second intermediate layer comprises at least one of MgF₂ and SiO₂.
